(19) United States
(12) Patent Application Publication
(10) Pub. No.: US 2008/0043076 A1
(43) Pub. Date: Feb. 21, 2008

(54) Vacuum Pump and Low Pressure Valve Inkjet Ink Supply

(76) Inventors: Johnnie Coffey, Winchester, KY (US); Steven Robert Komplin, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/427,037

(22) Filed: Jun. 28, 2006

(51) Int. Cl. B41J 2/19

(52) U.S. Cl. 347/92

(57) ABSTRACT

An ink container is provides ink to a vented printhead, where both the ink container and the vented printhead are positioned on a moveable carriage. The ink container receives ink from an off-carriage ink supply via an ink conduit. Air is removed from the printhead and ink container via a low pressure vacuum pump coupled to the ink container via an air conduit. The low pressure vacuum pump generates low pressure to pull air from the ink container. A higher pressure pump may be used in conjunction with a pressure relief valve that limits the pressure in the ink container.

### FIELD OF THE INVENTION

The present invention relates generally to inkjet printers, and more specifically, to devices, methods, and systems for removing air from ink containers supplying inkjet printheads.

### BACKGROUND OF THE INVENTION

Ink jet printers are used commonly in offices and home printing applications. They are popular due to their low cost of operation, low energy use and quiet operating features. Ink jet printing involves the ejection of tiny ink droplets through small holes, in a controlled manner, to create the desired image on the media intended to receive the image. Ink is supplied from an ink reservoir to a printhead, which includes various passageways from the reservoir to a plurality of firing chambers having nozzle orifices. Energy is applied to the ink from an ink droplet generator near each orifice, which may include the application of electrostatic attraction, the application of oscillating forces from piezo elements, the application of heat from heating elements or the like.

It is known to provide the nozzle orifices in a printhead cartridge that is mounted on a carriage that may support one or more such printheads. The carriage traverses back and forth across the medium being printed, and ink droplets are emitted as the carriage moves. One of the ways in which ink jet printing can be made faster is simply to move the carriage faster as the ink droplets are emitted. In doing so, it is desirable to minimize the amount of ink contained within the cartridge carried on the carriage, to reduce the weight and thus the momentum of the carriage. Further, the repeated and abrupt reversal in movement direction of the carriage traversing back and forth across the media can create turbulence in the ink, which in turn can cause printing problems due to air absorption, ink foaming and the like.

For some large printing devices, such as plotters used to create drawings, posters or other large printing jobs; or for printers such as color printers and printers designed for high volume print service utilizing large volumes of ink in relatively short time periods, carrying a reasonable volume of ink in the ink cartridge on the carriage has become impractical. If a small volume of ink is carried to reduce weight and momentum of the carriage, frequent change is necessary as the ink supply is rapidly diminished. Alternatively, carrying a large volume of ink in the cartridge makes the cartridge large and heavy, neither of which is desirable for a fast moving carriage.

To satisfy the goal of reducing carriage weight, and to provide adequate ink volumes for printers requiring such, it has been known to provide large volume, off carriage ink reservoirs, which are stationary in the printer. A flexible tube connects the ink reservoir to the ink cartridge on the carriage, and only a small amount of ink need be carried within the cartridge itself.

However, the use of off-carriage ink reservoirs presents its own unique set of problems. It is most often necessary to operate an off carriage ink delivery system at a slight negative or back pressure, to prevent ink dripping from the nozzles. However, back pressure that is too high can result in the printhead becoming deprimed, creating additional printing problems. Further, high back pressure can draw air into the ink supply system, which then can become trapped within the ink, causing even further printing problems.

What is needed is an ink delivery system that overcomes the aforementioned problems by providing for air removal in the system while simultaneously providing ink to a printhead. It would be advantageous for such a system to include a low pressure pump that provides air removal while preventing damage to system components.

### BRIEF SUMMARY OF THE INVENTION

In some embodiments of the invention, there is disclosed an apparatus including a valve operable to move from an open state to a closed state. The apparatus includes a frame, a check element affixed to the frame by a flexible thin film that is separate from the frame and the moveable check element, a stop element, where the stop element is operable to abut the check element; and at least one actuation member that abuts the check element to facilitate actuation of the check element.

In some embodiments of the invention, the check element is constructed from a thermoplastic elastomer (TPE). According to another aspect of the invention, both the check element and the flexible thin film are constructed from a thermoplastic elastomer (TPE). According to yet another aspect of the invention, the check element includes a hole through the center of the check element. The stop element may also or alternatively include a hole through its center.

In some embodiments of the invention, the at least one actuation member can include a spring. The frame may also include at least one pass-through hole, which may act as an inlet or an outlet. The frame may additionally retain fluid and/or ink. According to one aspect of the invention, the apparatus includes at least one actuator, separate from the at least one actuation member, operable to assist in moving of the moveable check element. Additionally, the check and/or stop elements may be moveable components to assist in the check element and stop element abutting each other.

In another embodiment of the invention, there is disclosed a method of constructing an apparatus that can include a valve. The method includes providing a frame, providing a check element affixed to the frame by a flexible thin film that is separate from the frame and the moveable check element, providing a stop element, wherein the stop element is operable to abut the check element, and providing at least one actuation member that abuts the check element to facilitate actuation of the check element.

In another of the invention, the check element is constructed from a thermoplastic elastomer (TPE). According to another aspect of the invention, both the check element and the flexible thin film are constructed from a thermoplastic elastomer (TPE). According to yet another aspect of the invention, the check element includes a hole through the center of the check element. The stop element may also or alternatively include a hole through its center.

In yet another embodiment of the invention, the at least one actuation member can include a spring. The frame may also include at least one pass-through hole, which may act as an inlet or an outlet. The frame may additionally retain fluid and/or ink. According to one aspect of the invention, the apparatus includes at least one actuator, separate from the at least one actuation member, operable to assist in moving of the moveable check element. Additionally, the check and/or stop elements may be moveable components to assist in the check element and stop element abutting each other.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an ink delivery system, according to an illustrative embodiment of the present invention.

FIG. 2 shows an alternative vacuum system that may be employed in the ink delivery system of FIG. 1, according to an embodiment of the present invention.

FIG. 3 shows an exploded view of an illustrative, low pressure vacuum pump that may be utilized as the pump of FIG. 1, according to an embodiment of the present invention.

FIG. 4 is a block diagram flow chart illustrating construction of the low pressure vacuum pump shown in FIG. 3, according to an embodiment of the present invention.

FIGS. 5a and 5b show a cross-sectional view of a diaphragm check valve, according to an embodiment of the present invention.

FIGS. 5c and 5d show a cross-sectional view of a diaphragm check valve, according to another embodiment of the present invention.

FIG. 5e shows a cross-sectional view of a pump including a diaphragm check valve, according to an embodiment of the present invention.

FIG. 5f shows a cross-sectional view of a relief valve incorporating a diaphragm check valve, according to an embodiment of the present invention.

FIG. 5g shows a cross-sectional view of a valve integrated with an ink tank or printhead, according to an embodiment of the present invention.

FIG. 6 is a perspective view of an ink container, according to an illustrative embodiment of the present invention.

FIG. 7 is a rear view of the ink container of FIG. 6, according to an illustrative aspect of the present invention.

FIG. 8 is an exploded view of the ink container of FIG. 6, showing ink film, screens and filters, according to an illustrative embodiment of the present invention.

FIG. 9 is a block diagram process flow illustrating the process that occurs during printer setup or during periodic air removal, according to an embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

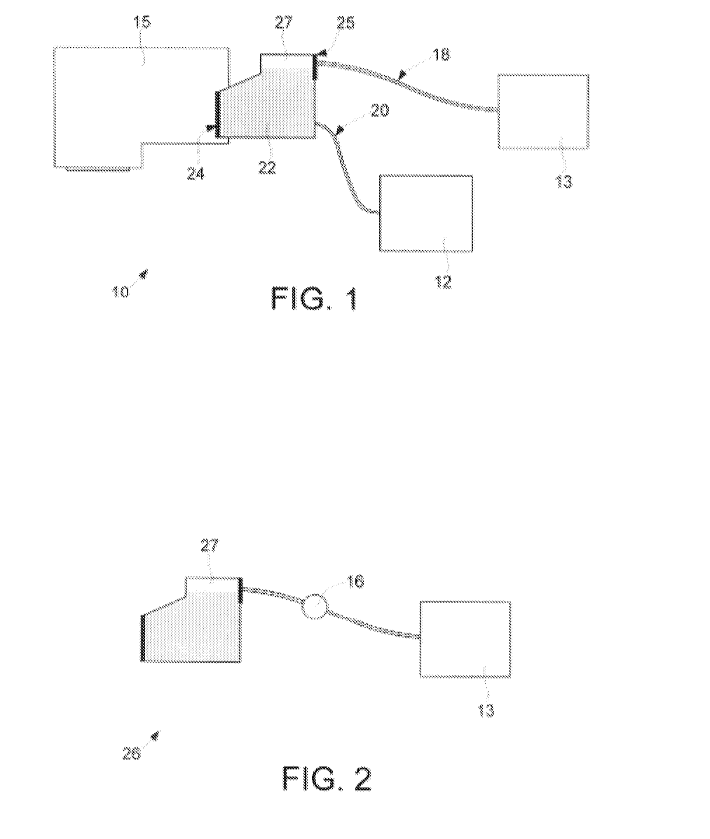

FIG. 1 shows an ink delivery system 10 according to an illustrative embodiment of the present invention. The ink delivery system 10 can be used in an ink jet printer, plotter, fax machine or the like, and is particularly useful in a high speed, high volume printing application. The ink delivery system 10 includes an ink supply item 12 and an ink container 22 that provides ink to a printhead 15. The ink supply item 12 is remote from the ink container 22, and an ink conduit 20, such as flexible tubing or the like, interconnects ink supply item 12 and ink container 22 such that ink contained in ink supply item 12 can be transmitted to ink container 22.

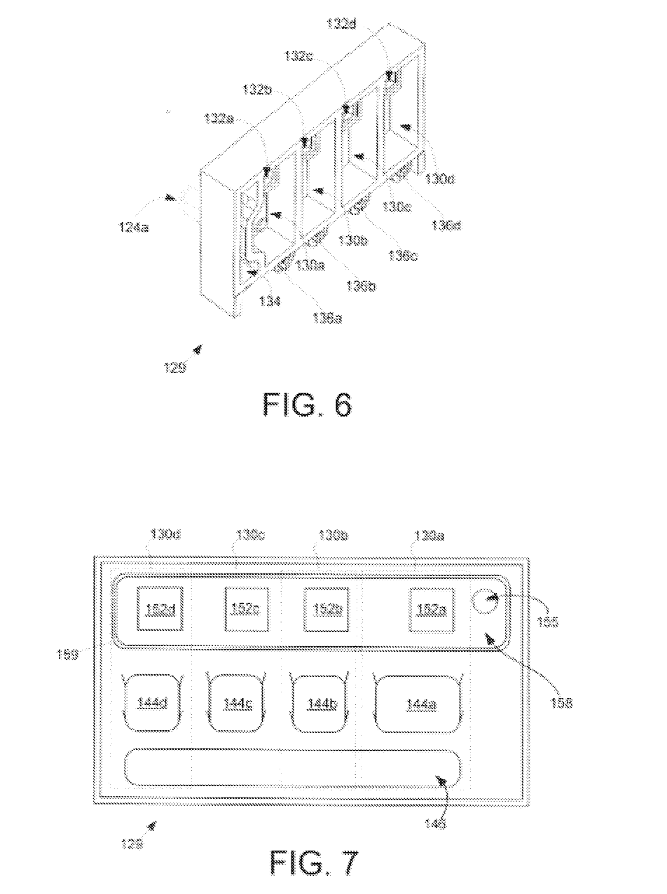

The ink container 22 is normally carried on a carriage that traverses back and forth in close proximity to the media upon which the printed image is being formed. The ink container 22 engages the printhead 15, which has an array of nozzles (not shown) from which ink droplets are emitted in the desired pattern and sequence for creating the desired image on the media intended to receive the printed image. As described in greater detail with respect to FIG. 6, the ink container 22 includes one or more ink reservoirs, and ink ducts, channels, vias and the like (not shown) by which ink is supplied to the printhead 15 for emission onto a printing surface. Ink droplet generators, such as piezo elements, heaters or the like are also provided. According to one aspect of the invention, the printhead 15 is a vented printhead that includes an ink refill opening to allow the printhead 15 to be semi-permanent in the ink delivery system 10. The structure and operation of a printhead 15 and the carriage on which the ink container 22 is mounted are well known to those skilled in the art and will not be described in further detail herein.

It will be appreciated that the ink supply item 12 includes a housing that encloses an ink reservoir (not illustrated), which may be a flexible bladder or the like, as those skilled in the art will readily understand. The ink supply item 12 may also include an outlet (not illustrated) that connects to the ink conduit 20. According to one aspect of the invention, the ink supply item 12 is mounted in a stationary manner in the printing device, and remains in place even as the carriage carrying ink container 22 traverses back and forth during a printing operation. Thus, the ink supply item 12 may be off carriage, as opposed to the ink container 22 and printhead 15, which may be both on carriage. The ink conduit 20 is sufficiently long and flexible to move as required, to maintain fluid flow communication between ink container 22 and ink supply item 12, even as the ink container 22 is moved during printing. According to another embodiment of the present invention, the ink supply item 12 may also be carried on the carriage such that it is on carriage.

As is shown in FIG. 1, the ink delivery system 10 includes a pump 13 that is coupled to an air conduit 18, which in turn is connected to an upper portion 27 of the ink container 22. A filter 25 is provided at the interface of the air conduit 18 and the upper portion 27 of the ink container 22. The ink within the ink container 22 is illustrated in FIG. 1 by the shaded region, such that the ink does not fill ink container 22 fully. That is, the ink does not fill up the entire upper portion 27 of the ink container. Air adjacent the air conduit 18 and the filter 25 can be removed. According to one aspect of the invention, the pump 13 is a vacuum pump, and removes air from the upper portion 27 of the ink container 22 via the air conduit 18, which may include flexible tubing or the like. According to one aspect of the invention, the pump 13 may be a low pressure diaphragm vacuum pump to keep the filter 25 from being damaged. According to another aspect of the invention, the pump 13 and/or air conduit 18 can include a pressure relief valve to maintain acceptable pressure levels in the air conduit and in the upper portion 27 of the ink container 22, which is described in the illustrative air removal system of FIG. 2. A pressure check valve can also be used to prevent air from returning to the ink container 22 and can also be separate from the pump 13. It will be appreciated that use of a pressure check valve permits the use of a leaky pump 13 in the system 10.

The filter 25 provided at the interface of the air conduit and the air removal portion 27 of the ink container 22 is operable to allow air to enter the air conduit 18 while preventing ink from entering the air conduit 18. According to one aspect of the invention, the filter is constructed of a hydrophobic mesh material, such as porous treated polysulphone, treated acrylic copolymers, porous polytetrafluoroethylene, or other treated polymers. Various hydrophobic materials are available from Pall Corporation or Gore Corporation. A suitable hydrophobic material for the filter 25 does not wet easily, and therefore retains a no-liquid pass property even as the material is contacted by ink from within the ink container 22, which can be useful when the ink level within the ink container 22 rises to the level of the filter 25 during operation of the ink delivery system 10. It will be appreciated that while only a single filter 25 is illustrated in the side view of the ink delivery system 10 shown in FIG. 1, several filters 25 may be used. For instance, a filter may exist for each color ink stored in individual reservoirs within the ink container, as will be described in greater detail with respect to FIG. 6.

Referring again to FIG. 1, the ink container 22 also includes at least one screen 24 at an ink supply interface with the printhead 15. Like the filter 25, several screens may exist and may each correspond to an ink reservoir within the ink container; however, only a single screen is illustrated in FIG. 1. Thus, for simplicity, the screen 24 shown in FIG. 1 may represent a screen corresponding to a single ink color and ink reservoir within the ink container 22. The screen 24 functions as an air check to minimize air from entering the ink container 22 from the printhead 15 while permitting ink to flow in both directions between the ink container 22 and the printhead 15. According to an aspect of the invention, the screen is a low resistance interface with the printhead 15, and interfaces with a felt within the printhead 15. According to another aspect of the present invention, the screen 24 may be a hydrophilic mesh screen, such as a stainless steel filter screen commonly used in ink jet cartridges. Typically a vented printhead can be used although with proper seals around the screen/felt connection a non-vented printhead could be used. According to one aspect of the invention, an alternate connection to the screen/felt connection with the printhead can include a needle/septum connection (i.e., a male projection and a female mating component) between the ink container and printhead. In this case a non-vented printhead would typically be used. In either case air is still removed from the ink container.

Because the ink supply item 12 is positioned at a lower height than the ink container 22 in the ink delivery system 10, the screen's 24 ability to prevent air from entering the ink container 22 prevents the ink within the ink container from draining back into the ink supply item 12. Additionally, it will be appreciated that air is accumulated within the ink container 22 away from the screen 24 to prevent high pressure from developing at the ink supply interface with the printhead 15, which could prevent the printhead 15 from being resupplied with ink.

As described above, the printhead 15 may be a vented printhead, and the ink required for operation will be provided directly from the felt, which receives the ink from the ink container 22. The felt in the printhead 15 can also include and/or be replaced by foam or fibrous materials. Ink used from the felt creates the pressure demand for ink replenishment. A non-vented printhead can have a flexible member to replace the capacitance function of the felt. Additionally, the removal of air from the ink container 22 supply subsystem permits ink to remain against the screen or supplied to the printhead thus keeping the pressure drop low. With this air removal configuration, the ink delivery system 10 can be shipped dry and then primed with ink during a machine initialization process. The air removal stops when ink is against filter 25, at this time the vacuum system only exerts pressure on the filter 25 and no longer on the ink container 22.

It will be appreciated by one of ordinary skill in the art that the height of ink in the off-carriage ink supply item 12 and the backpressure of ink in the felt of a vented printhead 15 are in equilibrium in the ink delivery system 10. Ink flows in or out of the printhead 15 to maintain this equilibrium. As an illustrative example, with all backpressure measured relative to the nozzle plate, if under normal conditions the ink supply item 12 ink fluid height is 4 cm below the printhead chip, then the printhead backpressure will be −4 cmH₂O when equilibrium exists. Continuing with this illustrative example, if the printhead backpressure increases to −5 cmH₂O then a 1 cmH₂O pressure draw to resupply ink to the printhead 15 is created. Ink will continue to flow until this differential is eliminated. The higher the backpressure difference the faster the ink is replenished to the printhead 15.

It will also be appreciated that during normal printing operations ink is supplied by the printhead 15. In the short term the ink is replaced by a combination of ink coming from the ink container 22 and air coming in through a vent in the printhead 15. As air comes into the printhead 15 the backpressure increases and pulls ink through the ink supply path until the air is replaced with ink. The printing and ink resupply system (which includes the ink container 22, ink conduit 20, and ink supply item 12) act asynchronously. The printhead 15 supplies peak flow requirements while the resupply subsystem replenishes ink at a delayed and normally slower rate. Instead of pulling air into the printhead 15 a non-vented printhead supplies part of the ink by changing volume. The volume change increases backpressure and will decrease and reach equilibrium when the ink is re-supplied and the volume returns to normal. A non-vented printhead system without volumetric changes requires all the demand volume to come from outside of the printhead.

FIG. 2 shows an alternative vacuum system 26 that may be employed in the ink delivery system of FIG. 1, according to an embodiment of the present invention. Unlike the air removal system illustrated in FIG. 1, which relies on a low pressure pump 13, the system of FIG. 2 includes a pressure relief valve 16 disposed in between the pump 13 and the ink container 22. This permits the use of a higher pressure pump 13 in the system 10. Nevertheless, like the air removal system of FIG. 1 (comprised of the pump 13 and the air conduit 18), the ink container 22 and pump 13 must be seated to achieve a vacuum such that air may be pulled from the ink container 22 during operation. Likewise, the pressure relief valve 16 must be sealed. According to another aspect of the invention, an additional valve may be added to prevent atmospheric leaks. For instance, if an additional valve (not illustrated) is added between the pressure relief valve and ink container 22, the pressure relief valve 16 may have a low level leak and not impact the pressure in the ink container 22.

Because the pump 13 must not exert too strong of a vacuum, which could damage the filter and result in ink flowing into the air conduit 18, the pressure relief valve 16 permits the use of a stronger pump that would otherwise exert too much pressure in the ink container 22. Thus, the pressure relief valve 16 may be opened while the pump 13 is operating, thereby reducing the suction generated in the ink container 22. As a result, the air removal system 26 shown in FIG. 2 may be implemented with either a high or low pressure pump 13. According to one aspect of the invention, the pressure relief valve 16 may be mechanically and/or automatically opened during operation of the pump 13, and may result in the pump 13 dropping pressure in the ink container by less than 1 psi. It will be appreciated by those of ordinary skill in the art that other pressures may be used, and that 1 psi is only an illustrative low pressure that may be used by the air removal system of the present invention.

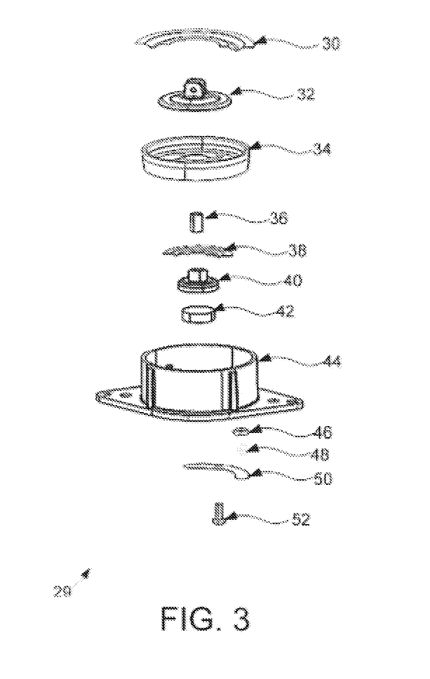

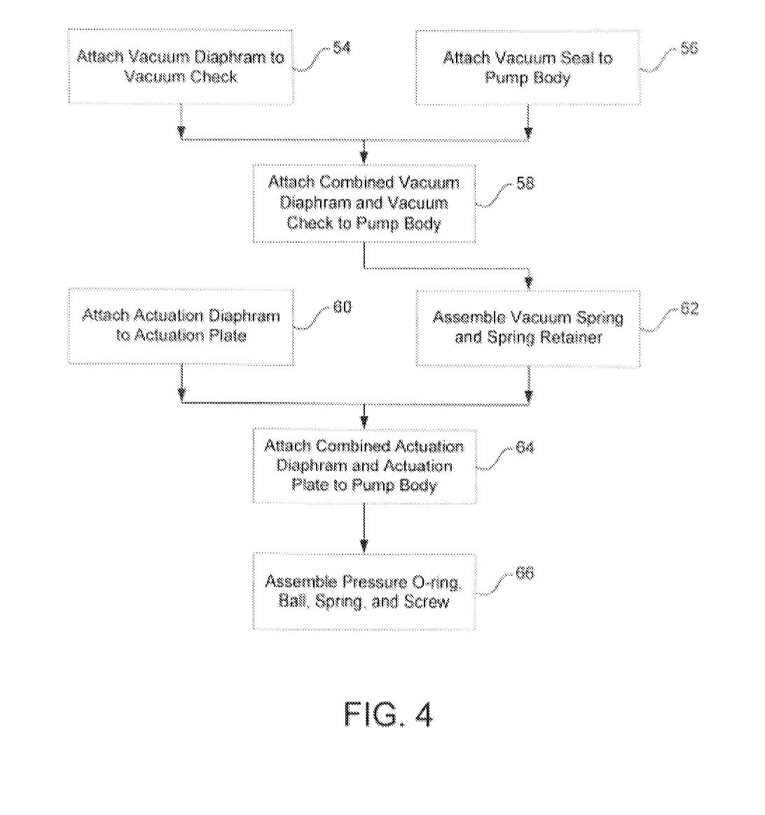

Next, FIG. 3 shows an exploded view of an illustrative, low pressure vacuum pump 29 that may be utilized as the pump 13 of FIG. 1, according to an embodiment of the present invention. FIG. 4 also illustrates a block diagram flow chart illustrating construction of the low pressure vacuum pump 29 shown in FIG. 3.

The low pressure pump 29 generally include vacuum, pressure, and actuation sections. To construct the pump 29, a vacuum seal 42 is mechanically attached to the pump body 44 (block 56). An assembly is then made by thermally attaching the film vacuum diaphragm 38 to the vacuum check 40 (block 54). This assembly is then located and sealed to the pump body 44, where the film vacuum diaphragm 38 is formed to make an operational vacuum diaphragm (block 58). The vacuum spring 36 and spring retainer 34 are added to the pump to complete the vacuum seal portion of the pump (block 62). It should be appreciate that this type of check seal can be used for the pressure relief valve described above with respect to FIG. 2. Next, the film actuation diaphragm 30 is thermally attached to the actuation plate 32 (block 60). This assembly 30, 32 is heat sealed to the pump body 44 and then the film is formed to create the actuation section of the pump (block 64). Finally, the pressure side seal is created by mechanically assembling the pressure O-ring 46, ball 48, spring 50, and screw 52 (block 66).

During operation, the actuation diaphragm 30 is flexed as the actuation plate 32 is moved back and forth. The draw stroke (for larger pump volume) opens the vacuum side, while the return stroke opens the pressure side of the pump. During the draw stroke, the vacuum seal 42, vacuum check 40, vacuum diaphragm 38, and vacuum spring 36 are opened when the vacuum differential across the vacuum diaphragm 38 is above its opening force, while the pressure components (46, 48, 50) remain sealed. The return stroke opens the pressure O-ring 46, pressure ball 48, and pressure spring 50 in a similar manner, while the vacuum components (36, 38, 40, 42) remain sealed. To control the maximum vacuum at the ink container 22, the draw stroke of the actuation plate 32 is spring limited. Although the return stroke can be driven back through an external (as illustrated) or internal spring, it may also be driven positively using a cam or the like that is operated by a motor (not illustrated), as is known to those of ordinary skill in the art. The vacuum portion of the system minimizes the valve actuation pressure.

According to one aspect of the invention, polypropylene-based film can be used to create the actuation diaphragm 30 and vacuum diaphragm 38. Additionally, the pump body 44 may be constructed from polypropylene. Similar compatible materials known to those of ordinary skill in the art may alternatively be used and/or substituted. Some other films are polyolefin based, polyethylene based, or multi-layer films. According to another aspect of the invention, the vacuum style section could replace the pressure section to create a lower pressure side of the pump. It will be appreciated that sealing film to multiple components creates low cost, large area diaphragms that may be employed in ink delivery systems of the present invention.

Using an air removal system with a pressure relief valve, as is illustrated in FIG. 2, permits the use of a positively driven vacuum stroke (as compared to a vacuum stroke driven through a spring) because the pressure relief valve will open if the vacuum level becomes too great. As described above, if the vacuum level is too high, the filter through which air passes from the ink container 22 to the air conduit 18 will fail and ink will pass through the filter into the air conduit. To ensure that a long term, low level vacuum does not create a failure in the filter, a small amount of air may be introduced back into the air container 22 after the air has been removed to decrease long term vacuum pressure. Relieving this pressure on the filter can be accomplished by opening up the pressure relief valve described with respect to FIG. 2, or by utilizing a leaky pump 13 and a secondary valve in the system shown in FIG. 1.

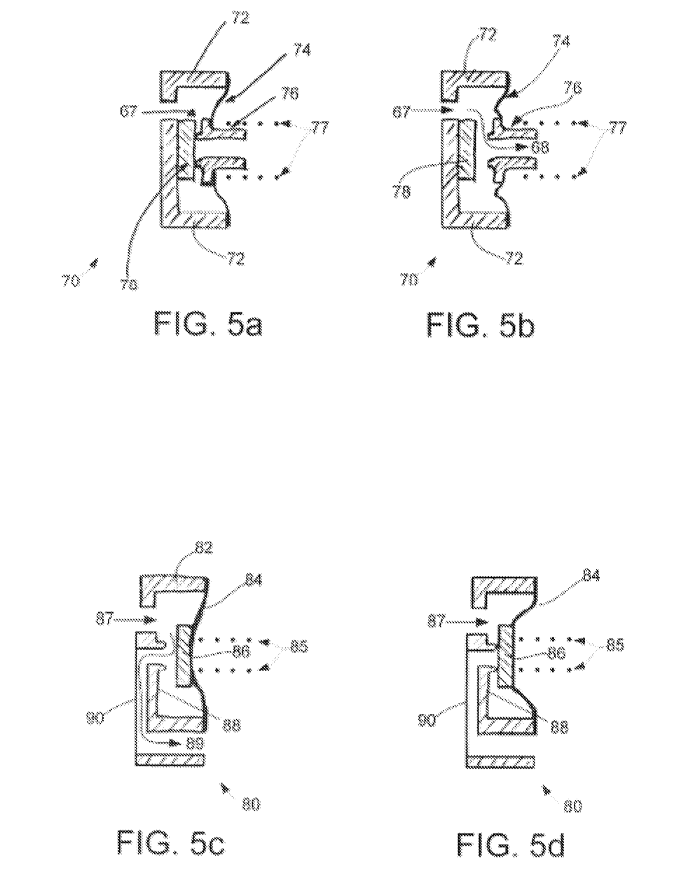

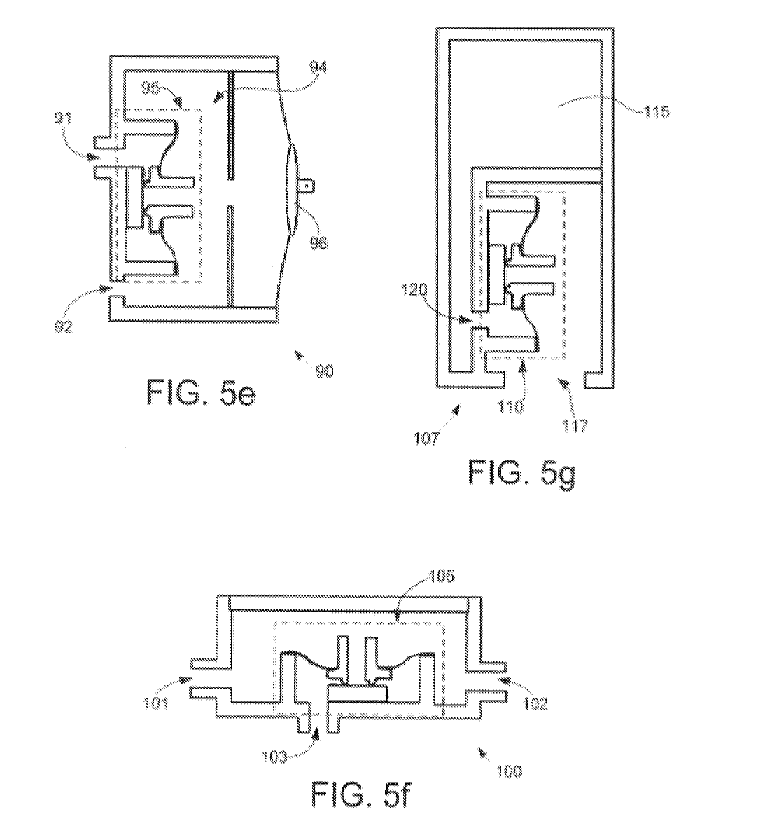

Next, FIGS. 5a and 5b illustrate a diaphragm check valve 70 that may be employed in a pump 13 of the present invention, such as the low pressure vacuum pump 29 of FIG. 3. FIG. 5a shows the diaphragm check valve 70 in a closed position, and FIG. 5b shows the diaphragm check valve 70 in an open position. According to one aspect of the invention, the check element 76 and/or stop element 78 are made out of a compliant member such as a thermoplastic elastomer (TPE), rubber, or the like. According to another aspect of the invention, the frame 72 may be constructed from a compatible material. It will be appreciated that the materials in contact with the film 74 should be compatible with an appropriate film attachment method, as the film 74 is sealed to the frame 72 and the check element 76. According to one aspect of the invention, the film 74 may be sealed by a thermal process. According to yet another aspect of the invention, the film 74 and check element 76 may be made out of a single piece of TPE material.

The diaphragm check valve 70 in FIGS. 5a and 5b include a pass-through hole to permit the passage of fluid (e.g., air or ink) 67 from the left, source side of the valve 70 through the center of the diaphragm valve 70 and out of the check element 76 on the right, non-source side when the check element 76 does not abut the stop element 78 in the open state. A compression spring 77 that abuts the check element 76 facilitates actuation of the check element 76 from the open state shown in FIG. 5b to the closed state shown in FIG. 5a.

When the diaphragm check valve 70 is in the closed position of FIG. 5a, the seal forces are greater than the pressure differential between the source side and non-source side times the effective area of the diaphragm. In contrast, the diaphragm check valve 70 will open by overcoming the closing force of the compression spring 77, which requires higher pressure on the supply side. However, if the pressure on the source side is limited or negative, and the pressure on the non-source side is limited, then the pressure difference may not open the valve 70, which is useful when a pump of limited strength is desired, as discussed above with respect to FIG. 1.

According to one aspect of the invention, the valve 70 shown in FIGS. 5a and 5b may be used as a relief valve where the source side is open to atmosphere and the non-source side is connected to the air removal system 16 shown in FIG. 2. If the non-source side pressure is decreased such that the difference in pressure opens the check valve 70 by overcoming the bias force, then air will enter the valve 70 and increase the non-source side pressure until the valve 70 closes.

According to another aspect of the invention, the low pressure diaphragm check valve 70 of FIGS. 5a and 5b can be used as a pressure regulator in an ink tank or printhead. Ink may exist on the non-source side, creating a pressure drop until the pressure differential overcomes the spring bias, allowing ink to transfer from the source side to the non-source side through the center of the valve 70. Ink will transfer until the pressure on the non-source side increases such that the sealing force closes the valve 70.

FIGS. 5c and 5d show a diaphragm check valve 80 according to another embodiment of the present invention. In particular, FIG. 5c shows the diaphragm check valve 80 in an open state, and FIG. 5d shows the check valve 80 in a closed state. The check valve 80 includes a stop element 86 that may be forced against an opening formed by a check element 88. A path 89 around the diaphragm 80 can be created by using a path seal 90, such as a plate or film attached to the frame 82. The path 89 is opened by a differential pressure that overcomes the biased member force, which is illustrated as a spring 85 (in cross section) in FIGS. 5c and 5d. The diaphragm check valve 80 shown in FIGS. 5c and 5d can be constructed of similar materials to the valve 70 of FIGS. 5a and 5b. However, it will be appreciated that the valves 80 shown in FIGS. 5c and 5d may include a film 84, such as a single elastomeric material such as a thermal polymeric elastomeric (TPE) material, which may be molded onto a ring without a pass-through hole, unlike the pass-through hole in the middle of the check valve 70 of FIG. 5a.

In an open state, air passes into an opening 87 on the left source side of the valve 80 passes a gap between the stop element 86 and the check element 88, and passes to the non-source side (to the right of the valve 80) via the path 89. Once this occurs, the pressure increases on the non-source side, decreasing the differential pressure between the source and non-source sides, resulting in a closing of the valve 80. As with the illustrative check valve 70 of FIGS. 5a and 5b, a spring 85 may be used to effect an initial bias. Alternatively, a material flex may be used to impart the bias, and/or other elements may be used, such as a leaf, extension, or torsion spring.

Next, FIG. 5e shows a pump 90 incorporating the valve 95 discussed above with respect to FIGS. 5a and 5b, according to one aspect of the invention. The pump 90 includes a fluid source inlet 91 and a fluid removal outlet 92. Pressure on the non-source side 94 is changed via movement of the actuator 96. The pump 90 shown in FIG. 5e may also utilize a valve similar to that shown in FIGS. 5c and 5d, according to an embodiment of the invention. FIG. 5f shows a relief valve 100 that also utilizes a valve 105 like those shown in FIGS. 5a, 5b, and 5e. The relief valve 100 may be a pressure check valve incorporated into the pump 13 and/or air conduit 18 to maintain acceptable pressure levels in the air conduit and in the upper portion 27 of the ink container 22, as is described with respect to FIG. 1. The relief valve 100 includes an inlet 101, which may be a supply provided from a printhead, and an outlet 102, which may be attached to a pump. The relief valve 100 also includes a fluid relief source 103. It will be appreciated that the relief valve 100 shown in FIG. 5f may utilize a valve similar to that shown in FIGS. 5c and 5d, according to an alternative embodiment of the invention.

FIG. 5g shows a valve 110 of the present invention for use in an ink tank or a printhead 107. In the open position, the valve 110 permits the passage of ink from an ink chamber 115 through an inlet 120 and out an outlet 117 via the valve 110. In the closed position the valve 110 prevents ink within the ink chambers 115 from exiting the chamber 115. It should be appreciated that other valves described herein may be used in place of the valve 110 shown in FIG. 5g. For instance, the valves described with respect to FIGS. 5c and 5d may alternatively be used in the ink tank or printhead 107. It should be appreciated that the valves of FIGS. 5e, 5f, and 5g have been illustrated without any valve bias method. This bias method could come from internal material properties, compression spring, extension spring, torsion spring, or other spring configuration.

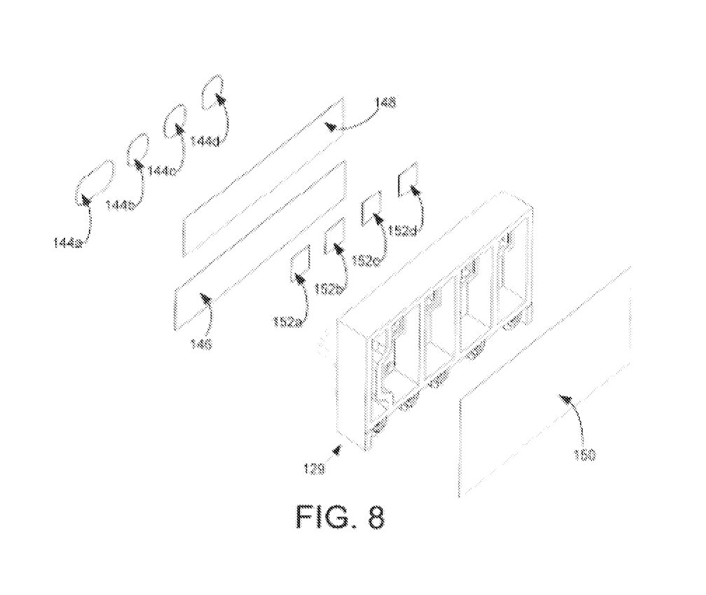

Referring once again to an ink container from which air is removed by the air removal systems described above, FIG. 6 shows a perspective view of an illustrative embodiment of an ink container 129 of the present invention. According to one aspect of the invention, the ink container 129 may be molded from plastic, such as by injection molding, and film may be later added to seal off chambers and channels, as is described below with respect to FIGS. 7 and 8. The ink container 129 shown in FIG. 6 includes four ink reservoirs 130a, 130b, 130c, 130d that receive ink via four respective ink conduits (not illustrated). The ink reservoirs 130a, 130b, 130c, 130d can each represent a different color ink used by the printhead. The ink conduits supply ink to the ink container from respective ink supply items, or from a single ink supply item having individual reservoirs for each ink color. The ink conduits that provide the ink to the ink reservoirs 130a, 130b, 130c, 130d feed the ink into reservoirs via ink conduit receptacles 136a, 136b, 136c, 136d associated with each ink reservoir 130a, 130b, 130c, 130d. Each ink reservoir, in turn, provides ink to the printhead via a corresponding ink supply projection, on which respective screens, as described above, are placed. A single ink supply projection 124a corresponding to the leftmost ink reservoir 130a of FIG. 6 is illustrated in the perspective view of FIG. 6. It will be appreciated that the ink container 129 of FIG. 6 is illustrative, and that only one, or a greater number of ink reservoirs may be utilized according to the present invention.

In this design an extra chamber is used to remove air from the system. Therefore, an air receptacle 134 is positioned in the ink container 129, which receives an air conduit (not illustrated) that pumps air out of the ink chamber 129. The air conduit may be received into a conduit receptacle within or connected to the air receptacle similar to the ink conduit receptacles 136a, 136b, 136c, 136d. As described in detail below, the air receptacle 134 includes an air removal opening in the ink container 129 that receives air from each of the ink reservoirs 130a, 130b, 130c, 130d, specifically, from air drains 132a, 132b, 132c, 132d that are integrated into the ink container 129.

Each air drain 132a, 132b, 132c, 132d is exposed to, or open to, an associated ink reservoir and permits air from the ink reservoir to flow through a respective filter (not illustrated) to the air conduit (not illustrated) via the air receptacle 134. According to one aspect of the invention, the air drains 132a, 132b, 132c, 132d may be covered by one or more filters that prevent the flow of ink within the reservoirs 130a, 130b, 130c, 130d into the air conduit. The back side of the ink container 129 of FIG. 6 is shown in FIG. 7. The air drains 132a, 132b, 132c, 132d are open to a common air chamber 158 on the back of the ink container 129. Additionally, the one or more filters 152a, 152b, 152c, 152d are disposed on the back side of the air drains 132a, 132b, 132c, 132d such that air passes through the filters 152a, 152b, 152c, 152d and into the common air chambers 158. Air leaves the common air chamber 158 via an air removal opening 155 and the air receptacle 134, through which air flows into the air conduit. As described with respect to FIG. 1, the air conduit, in turn, is connected to the pump 13, which pulls air from the tank container 129, and more specifically, from each ink reservoir via the common air chamber 158.

As shown in FIG. 7, the filters 152a, 152b, 152c, 152d are attached to the ink container 129 on the back side, or rear, of the ink container directly opposite the air drains 132a, 132b, 132c, 132d. Although illustrated as separate items, the filters may include a single piece of material that extends across all of the rear sides of the air drains 132a, 132b, 132c, 132d. According to another aspect of the invention, the filters 152a, 152b, 152c, 152d may also be attached to the ink container 129 on the inside of the individual ink reservoirs 130a, 130b, 130c, 130d, and more specifically, in or covering the air drains 132a, 132b, 132c, 132d.

For illustrative purposes, the general location of the ink reservoirs 130a, 130b, 130c, 130d are illustrated with dashed lines in FIG. 7, which also illustrates that the common air chamber 158 extends across all of the air drains 132a, 132b, 132c, 132d and filters 152a, 152b, 152c, 152d. Additionally, FIG. 7 illustrates the ink supply projections corresponding to each ink reservoir 130a, 130b, 130c, 130d, each ink supply projection having a screen 144a, 144b, 144c, 144d thereon for interfacing with the printhead 15, as was described above with respect to FIG. 1. As is also illustrated in FIG. 1 and FIG. 7, the ink supply projections are generally angled downward to facilitate the flow of air toward the upper portion 27 of the ink container 22, 129. As referenced above, it will be appreciated that the screen interface to the printhead can be replaced, as appropriate, with a needle/septum interface.

FIG. 8 shows an exploded view of film used to enclose chambers of the illustrative ink container 129 described with respect to FIGS. 6 and 7. It will be appreciated that each of the openings and channels in the ink container 129 may be sealed using film. According to another embodiment, welded plates may replace the film. Thus, the common air chamber is created by covering the chamber with vacuum film 148, which seals the air chamber so that air can be removed from the chamber 158 by the pump. It will therefore be appreciated that the ink container 129 is molded with a wall 159 (or perimeter) that extends outwardly to receive the vacuum film 148 and to enclose the filters 152a, 152b, 152c, 152d. Similar walls exist to receive the ink film 146 which completes passages opposite the ink conduit receptacles 136a, 136b, 136c, 136d, and the air receptacles 134 and ink reservoirs 130a, 130b, 130c, 130d. The body film 150 completes the air receptacle 134 and ink reservoirs 130a, 130b, 130c, 130d.

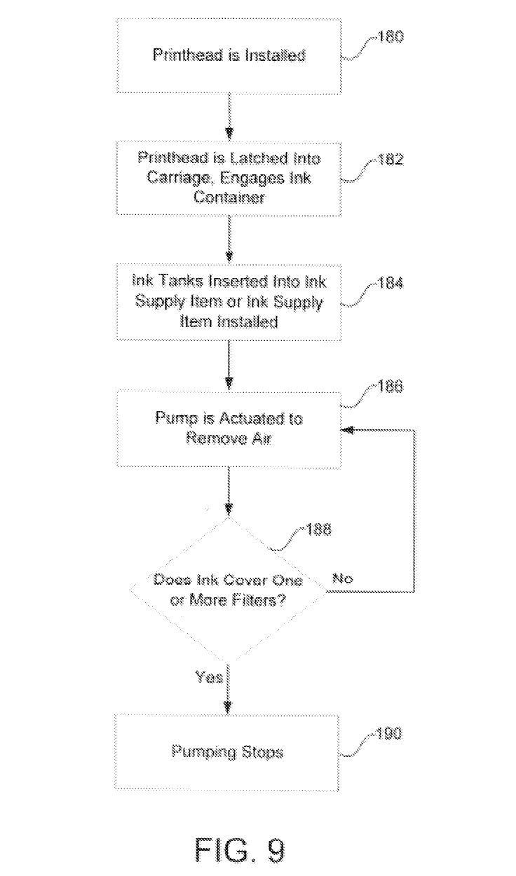

FIG. 9 is a block diagram flow chart illustrating the process that occurs during printer setup or during periodic air removal in a printer having an ink delivery system of the present invention. During initial setup, a semi-permanent printhead having a vent is installed (block 180). The printhead is latched into the carriage (block 182), which causes the printhead to engage the ink container, and more particularly, causes the felt of the printhead to engage one or more screens at the at the ink supply interface with the printhead. In like manner a non-vented printhead could have the needles and septums engaged. Ink tanks may then be inserted into the ink supply item and/or the ink supply item may be inserted (block 184). After the components are installed, a cover may be closed and the pump is actuated to remove air from the ink container (block 186).

It will be appreciated that ink from the printhead will wet the one or more screens such that a large quantity of air will not pulled into the ink container from the printhead. Thus, the pump, which may be a low pressure vacuum pump, is actuated as many times as required (blocks 186, 188) to remove the air from the ink container and replace it with ink. This ink comes primarily from the ink supply item although initially a small amount comes from the printhead. Air stops being removed from the system when ink covers the filters (block 190). Additional pump actuation does nothing to the system since the pressure generated is limited so ink is not pulled through the filters. To achieve backpressure equilibrium between the printhead and off carrier ink source, ink may either come into or leave the printhead. Periodic actuation of the pump can remove any air that may accumulate over time.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A valve, comprising:
a frame;
a movable element;
a stationary element;
a flexible thin film that connects the movable element and the frame;
wherein the movable element, the stationary element, the film, and the frame define a fluidic path; and
an actuation member that interacts with the movable element to interrupt a movement of a fluid through the fluidic path.

2. The valve of claim 1, wherein at least one of the movable element and the stationary element is constructed from a thermoplastic elastomer (TPE).

3. The valve of claim 1, wherein the movable element and the flexible thin film are constructed from a thermoplastic elastomer (TPE).

4. The valve of claim 1, wherein the flexible thin film is melt compatible with the frame and the movable element.

5. The valve of claim 1, wherein the flexible thin film is constructed from at least one of polypropylene, polyethylene, polyolefin, thermoplastic elastomer (TPE) and multi-layer film.

6. The valve of claim 1, wherein the actuation member comprises a spring.

7. The valve of claim 1, wherein the frame has at least one pass-through hole.

8. The valve of claim 1, wherein the frame retains fluid.

9. The valve of claim 8, wherein the frame retains ink.

10. The valve of claim 1, further comprising at least one actuator, separate from the actuation member, operable to assist in moving the movable element.

11. The valve of claim 1, wherein the stationary element has a hole disposed in it.

12. A method of constructing an apparatus including a valve, comprising:
providing a frame;
affixing a check element to the frame by a flexible thin film that is separate from the frame and the check element;
adding a stop element to abut the check element; and
adding at least one actuation member that abuts the check element and facilitates an actuation of the check element.

13. The method of claim 12, wherein at least one of the check element and stop element is constructed from a thermoplastic elastomer (TPE).

14. The method of claim 12, wherein the flexible thin film is at least partially constructed from at least one of polypropylene, polyethylene, polyolefin, thermoplastic elastomer (TPE) and multi-layer film.

15. The method of claim 12, wherein the at least one actuation member comprises a spring.

16. The method of claim 12, wherein the frame comprises at least one pass-through hole.

17. A valve, comprising:
a frame;
first and second structures operably attached to the frame, wherein at least one of the first and second structures is movable with respect to the frame;
a flexible thin film affixed to the valve frame and to the movable structure; and
an actuation member that abuts the movable structure and facilitates movement of the movable structure.
